(19) United States
(12) Patent Application Publication
(10) Pub. No.: US 2023/0306711 A1
(43) Pub. Date: Sep. 28, 2023

(54) MONITORING SYSTEM, CAMERA, ANALYZING DEVICE, AND AI MODEL GENERATING METHOD

(71) Applicant: HITACHI KOKUSAI ELECTRIC INC., Tokyo (JP)

(72) Inventors: Hiroto SASAO, Tokyo (JP); Keigo HASEGAWA, Tokyo (JP)

(21) Appl. No.: 18/043,198

(22) PCT Filed: Sep. 17, 2020
(86) PCT No.: PCT/JP2020/035229

§ 371 Date: Feb. 27, 2023

(51) Int. Cl. G06V 10/70; H04N 7/18; G06V 20/40; G06V 40/10; G06V 10/94

(52) U.S. Cl. CPC G06V 10/70; H04N 7/181; G06V 20/41; G06V 40/10; G06V 10/95

(57) ABSTRACT

An Objective of the present invention is to improve the inter-camera cooperation in a monitoring system comprising multiple cameras each having a function to perform video analysis by use of an AI model. A monitoring system according to the present example comprises: multiple AI cameras 101 each having a function to perform video analysis by use of an AI mode; and an analyzing device 102 that generates the AI model used in the AI cameras 101. Each of the AI cameras 101 detects suspicious behaviors through video analysis using a particular-behavior detection AI model for detecting the suspicious behaviors. When suspicious behaviors are detected by any of the AI cameras 101, the analyzing device 102 generates a particular-person detection AI model for detecting a particular person (suspicious person) having done the suspicious behaviors, and transmits the particular-person detection AI model to each of the AI cameras 101. Each of the AI cameras 101 detects the suspicious person through video analysis using the particular-person detection AI model.

### TECHNICAL FIELD

The present invention relates to a monitoring system with a plurality of cameras having a function of analyzing videos by using an AI model.

### BACKGROUND ART

Video monitoring systems for providing video monitoring for 24 hours by using an image capturing device such as a monitoring camera have been widely used. In recent years, a technology for monitoring by using AI (artificial intelligence) has been examined in addition to human monitoring by a monitor. A video monitoring system using AI is equipped with a function of storing only the minimum required information such as a video showing the appearance of a certain object and the time thereof, and a function of attracting attention by a monitor by means of an indication of an alarm icon and the ringing of a buzzer by a display device. Therefore, such a video monitoring system using AI is helpful for the reduction of the burden of the monitoring work as compared to the prior art system where confirmation is necessary all the time.

As for the analysis that has been studied for a long time such as facial recognition and license plate number detection, optimization concerning the analysis with a low operation amount has been progressed in order to make real-time processing possible within a camera. In contrast, AI analysis of which the main focus is deep learning requires an extremely large calculation amount, and therefore, in many cases is implemented by using a dedicated analysis server or a cloud. In recent years, AI chips to be built in have been developed so much that it is becoming possible for some AI analyses to be processed in real-time inside a camera. For example, Patent Literature 1 discloses a camera having a plurality of learning models that can be switched with each other.

### CITATION LIST

### Patent Literature

Patent Literature 1: Japanese Patent No. 6641446

### SUMMARY OF THE INVENTION

### Problems to be Solved by the Invention

AI analysis precision (for example, detection precision of a certain object) is a very important factor of a video monitoring system using AI. As an AI video monitoring system according to the prior art, a system for carrying out AI analysis by means of a server or a cloud on a video that has been gained by each of a plurality of cameras and a system for carrying out AI analysis inside the respective cameras have been constructed. However, the cooperation between the cameras is not taken into consideration in these AI video monitoring systems, and therefore, it is difficult to track an object to be detected across a plurality of cameras.

The present invention has been made in view of the above-described conventional situation, and an object thereof is to increase the cooperation between cameras in a monitoring system with a plurality of cameras having a function of video analysis by using an AI model.

### Means for Solving Problems

In order to achieve the above-described object, the monitoring system according to the present invention is constructed as follows.

That is to say, the monitoring system according to the present invention is provided with: a plurality of cameras having a function of video analysis by using an AI model; and an analyzing device for generating an AI model that can be used in the cameras, and is characterized in that: the plurality of cameras respectively detects a certain action through video analysis by using a first AI model for detecting a certain action; the analyzing device generates a second AI model for detecting a certain object that has carried out a certain action in the case where the certain action is detected by any of the cameras, and transmits the second AI model to one or more of the plurality of cameras; and the one or more cameras detects the certain person through video analysis by using the second AI model.

Here, the analyzing device may regenerate the second AI model in the case where a certain person is detected through video analysis by using the second AI model so as to transmit the regenerated second AI model to one or more of the plurality of cameras.

In addition, the one or more cameras may include a camera that is away from the camera that has detected the certain action by a distance that is smaller than a threshold value.

Moreover, the present invention can be implemented as a camera having a function of video analysis by using an AI model. That is to say, the camera according to the present invention is characterized by carrying out: a process for detecting a certain action through video analysis by using a first AI model for detecting a certain action; a process for notifying an analyzing device in the case where a certain action is detected; a process for receiving a second AI model for detecting a certain object that has carried out the certain action from the analyzing device; and a process for detecting the certain object through video analysis by using the second AI model.

Furthermore, the present invention can be implemented as an analyzing device for generating an AI model that can be used for video analysis within a camera. That is to say, the analyzing device according to the present invention is characterized by carrying out: a process for generating a second AI model for detecting a certain object that has carried out a certain action in the case where any of a plurality of cameras has detected a certain action through video analysis by using a first AI model for detecting a certain action; and a process for transmitting the second AI model to one or more of the plurality of cameras.

In addition, the present invention can be implemented as an AI model generating method for generating an AI model that can be used for video analysis within a camera. That is to say, the AI model generating method according to the present invention is characterized by having the steps of: allowing an analyzing device to generate a second AI model for detecting a certain object that has carried out a certain action in the case where any of a plurality of cameras has detected the certain action through video analysis by using a first AI model for detecting a certain action; and allowing the analyzing device to transmit the second AI model to one or more of the plurality of cameras.

### Advantageous Effects of the Invention

The present invention makes it possible to increase the cooperation between cameras in a monitoring system with a plurality of cameras having a function of video analysis by using an AI model.

### BRIEF DESCRIPTION OF DRAWINGS

FIG. 1 is a diagram showing a schematic configuration of the monitoring system according to one embodiment of the present invention;

FIG. 2 is a diagram showing an example of the configuration of an AI camera;

FIG. 3 is a diagram showing an example of the configuration of an analyzing device; and

FIG. 4 is a flow chart showing an example of a process flow for detecting a suspicious person.

### DESCRIPTION OF EMBODIMENTS

The monitoring system according to one embodiment of the present invention is described in reference to the drawings. The following description relates to an example of a monitoring system for the purpose of detection of a suspicious person in a monitored area. Here, the suspicious person means a person who carries out an unexpected suspicious action (including an abnormal action) but is not detected at a usual time. As examples of a suspicious person, a person who trespasses in an off-limits area, a person who leaves a personal item, and a person who carries out other suspicious actions can be cited.

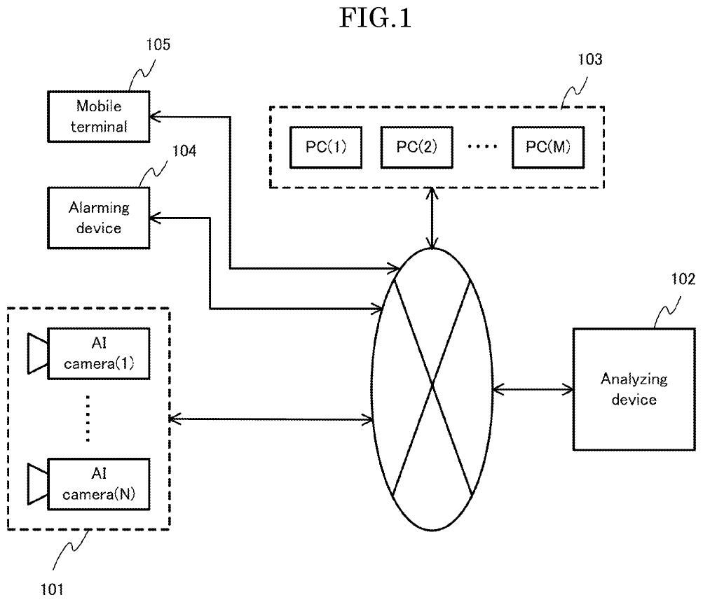

FIG. 1 shows an example of the configuration of the monitoring system according to one embodiment of the present invention. The monitoring system of the present embodiment is provided with one or more (N in FIG. 1) AI cameras 101, an analyzing device 102, one or more (M in FIG. 1) PCs 103, an alarm issuing device 104, and a portable terminal 105, which are connected to each other so as to be communicable via a communication network such as the Internet. Here, one or more alarm issuing devices and one or more portable terminals may be provided in addition to the alarm issuing device 104 and the portable terminal 105.

The AI cameras 101 are image capturing devices that have functions of not only capturing a video of the monitored area, but also analyzing the video on the basis of an AI model. An AI model for detecting a certain action is preset in the AI cameras 101 in order to detect a suspicious action. As described below, in the case where any of the AI cameras 101 has detected a suspicious action, an AI model for detecting a certain person that is appropriate for tracking a certain person who has carried out the suspicious action (that is to say, a suspicious person) is additionally set. Each of the AI cameras 101 not only discovers a suspicious person by using the AI model for detecting a certain action (first detection of a suspicious person), but also tracks the suspicious person by using the AI model for detecting a certain person (second and so forth detections of the suspicious person). In addition, an identifier (for example, camera number) for identifying each AI camera is associated with each of the AI cameras so as to be added to the communication data with other devices such as the analyzing device 102 and the PCs 103.

The analyzing device 102 stores the videos and the results of analysis thereof that have been gained by the respective AI cameras 101, and at the same time integrates and reanalyzes the results of analysis. In the case where a suspicious action has been detected through video analysis in any of the plurality of AI cameras 101, the analyzing device 102 carries out a process for generating an AI model for detecting a certain person in order to detect a suspicious person who has carried out the action, and a process for transmitting the AI model for detecting a certain person to the respective AI cameras 101.

The AI model for detecting a certain action is generated through deep learning on the basis of a video taken in the past which contains a certain action that has been labeled as a suspicious action, for example. The AI model for detecting a certain person is generated on the basis of characteristics data that is gained through the analysis of a video where a suspicious action has been detected, which contains physical characteristics of the suspicious person (age, sex, height, facial features, body type, skin color, hairstyle, hair color, and the like), the attire, and possessions, for example. In the case where the characteristics data of the suspicious person is not sufficiently gained from the video at the point in time when the suspicious action has been detected, the characteristics data of the suspicious person may be acquired from the video that has been taken before or after the point in time of detection. The AI model for detecting a certain action is generated before the start of the operation of the monitoring system so as to be set in the respective AI cameras 101 and updated if necessary. Meanwhile, the AI model for detecting a certain person is automatically generated in response to the discovery of a suspicious person and set in the respective AI cameras 101.

The PC 103 accesses an AI camera 101 or the analyzing device 102 in response to the operation by the user so as to display a video in the past or at present of an area to be monitored and the results of analysis thereof. The alarm issuing device 104 issues an alarm in response to a detection signal that is transmitted from an AI camera 101 at the time of detection of a suspicious person. The portable terminal 105 displays a video and the results of analysis thereof that are transmitted from an AI camera 101 at the time of detection of a suspicious person. Here, the results of analysis by an AI camera 101 includes one or more of the coordinates of the detected suspicious person(s) within the video, the number of detected persons, the detection attribute (sex, age, height, nationality, and the like of the suspicious person(s)), the time and date of detection, and the place of detection.

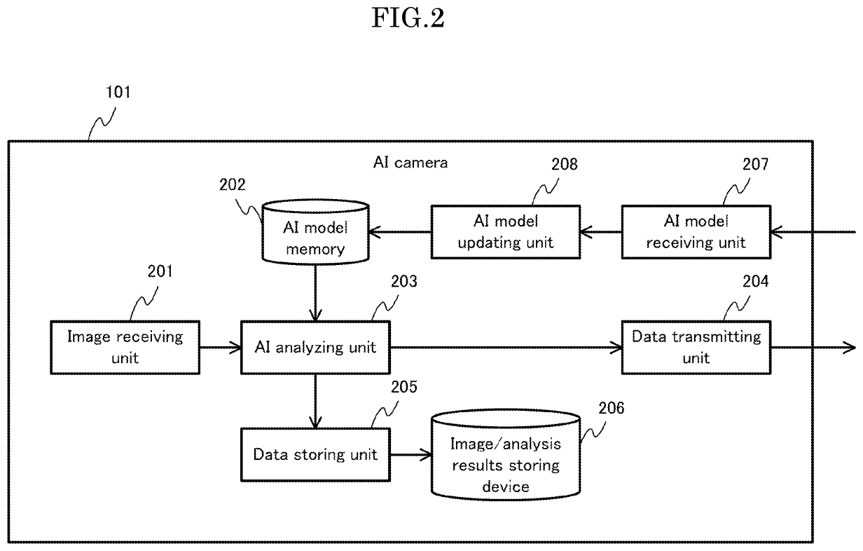

FIG. 2 shows an example of the configuration of an AI camera 101. The AI camera 101 has functional units such as a video receiving unit 201, an AI analyzing unit 203, a data transmitting unit 204, a data storing unit 205, an AI model receiving unit 207, and an AI model updating unit 208, and storage units such as an AI model memory 202 and a video/analysis results storage device 206. In terms of hardware, the AI camera 101 is provided with an ISP (image signal processor) for carrying out a correction process and a clarifying process on the optical system including a lens, a GPU (graphics processing unit) or an FPGA (field programmable gate array) for rapidly carrying out AI analysis, or other AI chips that can substitute these.

The video receiving unit 201 acquires a video from an image sensor such as a CCD (charge-coupled device) or a CMOS (complementary metal-oxide-semiconductor). The AI analyzing unit 203 analyzes a video that has been acquired in the video receiving unit 201 by means of the AI models within the AI model memory 202 (that is to say, an AI model for detecting a certain action and an AI model for detecting a certain person). The data transmitting unit 204 transmits data such as a video that has been acquired in the video receiving unit 201 and the results of analysis in the AI analyzing unit 203. The data storing unit 205 stores data, such as a video that has been acquired in the video receiving unit 201 and the results of analysis in the AI analyzing unit 203, in the video/analysis results storing device 206. The AI model receiving unit 207 receives an AI model from the analyzing device 102. The AI model updating unit 208 updates an AI model within the AI model memory 202 with an AI model that has been received in the AI model receiving unit 207.

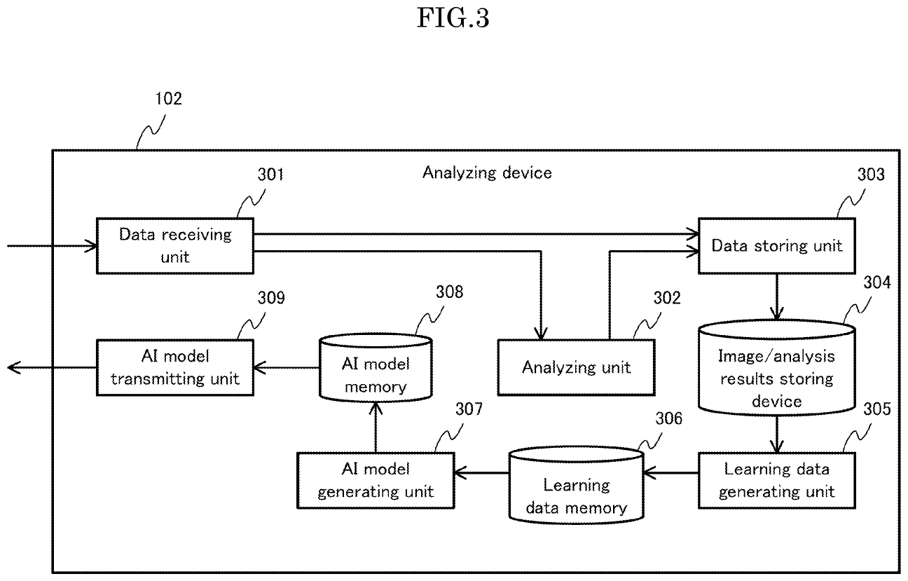

FIG. 3 shows an example of the configuration of the analyzing device 102. The analyzing device 102 has functional units such as a data receiving unit 301, an analyzing unit 302, a data storing unit 303, a learning data generating unit 305, an AI model generating unit 307, and an AI model transmitting unit 309, and storing units such as a video/analysis results storing device 304, a learning data memory 306, and an AI model memory 308. In addition, the analyzing device 102 is formed of a cloud or an electronic calculator system that is provided with a CPU (central processing unit), a GPU, and an FPGA as hardware, and performs processing of the respective functional units (described below).

The data receiving unit 301 receives data such as a video and the results of analysis thereof that are transmitted from an AI camera 101. The analyzing unit 302 carries out reanalysis on the basis of the video and the results of analysis thereof that have been received in the data receiving unit 301. The reanalysis by the analyzing unit 302 is an analysis that is more detailed than the analysis by AI cameras 101, or an integrated or cross-sectional analysis by using videos from a plurality of AI cameras 101. The data storing unit 303 stores the videos and the results of analysis thereof that have been received in the data reception unit 301, the data that has been reanalyzed in the analyzing unit 302, and the like in the video/analysis results storing device 304. The learning data generating unit 305 uses the videos and the results of analysis thereof that are stored in the video/analysis results storing device 304 so as to generate learning data for an AI model and stores the learning data in the learning data memory 306. The AI model generating unit 307 uses the learning data within the learning data memory 306 so as to generate an AI model and stores the AI model in the AI model memory 308. The AI model transmitting unit 309 transmits the AI model within the AI model memory 308 to the AI cameras 101.

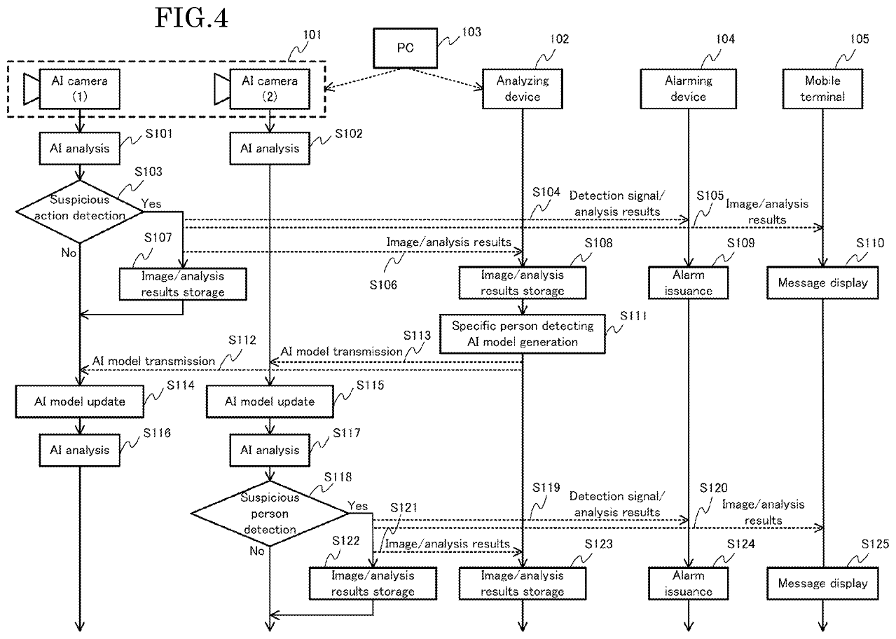

FIG. 4 shows an example of the process flow for the detection of a suspicious person in the monitoring system according to the present embodiment. Here, there are two types of suspicious person detecting processes: a certain action detecting process for discovering a suspicious person (first detection of a suspicious person) by using an AI model for detecting a certain action and a certain person detecting process for tracking the suspicious person (second or so forth detection of the suspicious person) by using an AI model for detecting a certain person.

In the video analyzing unit 203, the AI camera (1) and the AI camera (2) use the AI model for detecting a certain action within the AI model memory 202 so as to carry out a suspicious action detecting process through the AI analysis on the video that has been taken by the AI camera and acquired in the video receiving unit 201 (steps S101 and S102). As a result, it is assumed that the AI camera (1) has detected a suspicious action (step S103). In this case, the AI camera (1) transmits a detection signal and the results of analysis to the alarm issuing device 104 in order to notify the monitor of the discovery of a suspicious person (first detection of a suspicious person) (step S104), and then also transmits the video portions during several seconds before and after the moment when the suspicious person was detected and the results of analysis to the portable terminal 105 and the analyzing device 102 (steps 105 and S106). As for the means of transmitting these pieces of data, a wired LAN, a wireless LAN that includes Wi-Fi, LTE, and 5G, and a contact can be used, for example. The video that is transmitted by the AI camera may be a snapshot (still picture) taken at the moment when the suspicious person was detected.

In addition, the AI camera (1) stores the same data as the transmitted video and the results of analysis thereof in the built-in video/analysis results storing device 206 (step S107). Here, the time when the data is stored may be before the transmission of the data including the video and the results of analysis thereof. Upon the reception of the video and the results of analysis thereof from the AI camera (1), the analyzing device 102 stores the received video and the results of analysis thereof in the built-in video/analysis results storing device 304 (step S108). Upon the reception of the detection signal and the results of analysis from the AI camera (1), the alarm issuing device 104 issues an alarm (step S109). The alarm can be issued by using a prerecorded speech sound, an alarm, an emergency bell, or light emission from a rotating light, for example. Upon the reception of the video and the results of analysis thereof from the AI camera (1), the portable terminal 105 displays the received video and a message that notifies the discovery of a suspicious person on the screen of the portable terminal 105 (step S110).

In response to the reception of the video and the results of analysis thereof from the AI camera (1), the analyzing device 102 generates an AI model for detecting a certain person in order to track the suspicious person that was discovered through the suspicious action detecting process (step S111). The analyzing device 102 transmits the generated AI model for detecting a certain person to the AI camera (1) and the AI camera (2) (steps S112 and S113). When the AI model for detecting a certain person is received in the model receiving unit 207, the AI camera (1) and the AI camera (2) allow the AI model updating unit 208 to store the received AI model for detecting a certain person in the AI model memory 202 (steps S114 and S115).

After that, the AI camera (1) and the AI camera (2) use the AI model for detecting a certain person within the AI model memory 202 so as to carry out a certain person detecting process through the AI analysis on the video that has been taken by the AI camera and acquired in the video receiving unit 201 (steps S116 and S117). As a result, it is assumed that the AI camera (2) has detected a suspicious person (step S118). In this case, the AI camera (2) transmits a detection signal and the results of analysis to the alarm issuing device 104 in order to notify the monitor of the detection of the suspicious person (second and so forth detection of the suspicious person) (step S119), and then also transmits the video portions during several seconds before and after the moment when the suspicious person was detected to the portable terminal 105 and the analyzing device 102 (steps S120 and S121). In addition, the AI camera (2) stores the same data as the transmitted video portions and the results of analysis in the built-in video/analysis results storing device 206 (step S122). The following operation of each device is basically the same as that when a suspicious person was discovered.

At the time of the second detection of the suspicious person, the analyzing device 102 regenerates the AI model for detecting a certain person on the basis of the video at the time of the first detection of a suspicious person (when the suspicious person was discovered) and the video portions at the time of the second detection of the suspicious person, and transmits the regenerated AI model to the respective AI cameras. In the same manner, when the suspicious person was detected afterwards, the analyzing device 102 regenerates the AI model for detecting a certain person on the basis of the videos at the time of the detection of the suspicious person that have been taken so far, and then transmits the regenerated AI model to the respective AI cameras. As a result, the learning data to be used for the generation of an AI model for detecting a certain person gradually increases, and thus, a more precise detection (tracking) of the suspicious person becomes possible.

It is also possible all the time to allow the PCs 103 to access an AI camera 101 and the analyzing device 102. Therefore, a PC 103 can be used to refer to the video that is delivered by an AI camera 101 in real time and the results of analysis thereof, or refer to a past video and the results of analysis thereof that are stored in the video/analysis results storing device 206 within an AI camera 101 or in the video/analysis results storing device 304 within the analyzing device 102.

As described above, the monitoring system according to the present embodiment is provided with: a plurality of AI cameras 101 having a function of video analysis by using an AI model; and an analyzing device 102 for generating an AI model to be used in an AI camera 101 in the configuration where: each AI camera 101 detects a suspicious action through video analysis by using an AI model for detecting a certain action in order to detect a suspicious action; in the case where any of the AI cameras 101 detects a suspicious action (in the case where a notification of the detection of a suspicious action is received), the analyzing device 102 generates an AI model for detecting a certain person in order to detect a certain person (suspicious person) that has carried out the suspicious action so as to transmit the generated AI model to the respective AI cameras 101; and each of the AI cameras 101 detects the suspicious person through video analysis by using the AI model for detecting a certain person.

Thus, in the monitoring system according to the present embodiment, in the case where a suspicious person is discovered through video analysis by using an AI model for detecting a certain action, an AI model for detecting a certain person that is appropriate for the detection of this suspicious person is provided to the respective AI cameras. As a result, the plurality of AI cameras can cooperate to detect the suspicious person, and therefore, it is possible to efficiently track the suspicious person. In addition, each AI camera analyzes a video that was taken by itself, and therefore, the detection of the suspicious person can be made closer to real time. Though one suspicious person is discovered and tracked in the above description, it is also possible to discover and track a plurality of suspicious people.

In the present embodiment, an AI model for detecting a certain person is provided to all the AI cameras so that the suspicious person can be tracked by using all of the AI cameras; however, an AI model for detecting a suspicious person may be transmitted to only some of the AI cameras. For example, an AI model for detecting a certain person may be transmitted only to the AI cameras that are away from the AI camera that has detected the suspicious action by a distance that is smaller than a threshold value. As for the threshold value, the distance that a person can move within a predetermined period of time can be used, for example. As a result, only the AI cameras within the range where the suspicious person can move within a predetermined period of time can be used to efficiently track the suspicious person. Thus, the process can be done without operating the AI cameras that are out of the above-described range in vain.

Though the present invention is described on the basis of one embodiment in the above, the present invention is not limited to the configuration that is described herein, but needless to say, can be widely applied to the systems with other configurations. For example, the present invention can be implemented as a monitoring system that uses an AI model for detecting a certain action made by an object to be monitored such as a vehicle, an animal, or cargo, and an AI model for detecting a certain object that has carried out the certain action.

It is also possible for the present invention to provide a method that includes a technological procedure concerning the above-described processes, a program for allowing the above-described processes to be carried out by a processor, a recording medium that can store such a program in a manner to be readable by a computer, and the like.

Here, the scope of the present invention is not limited to the illustrative embodiment that is shown in the figures and described herein, but includes all the embodiments having equivalent effects that match the object of the present invention. Furthermore, the scope of the present invention can be defined by any desired combination of any specific characteristics from among all the characteristics that are disclosed herein.

### INDUSTRIAL APPLICABILITY

The present invention can be applied to a monitoring system with a plurality of cameras having a function of video analysis by using an AI model.

### REFERENCE SIGNS LIST

101: AI camera
102: Analyzing device
103: PC
104: Alarm issuing device
105: Portable terminal
201: Video receiving unit
202: AI model memory
203: AI analyzing unit
204: Data transmitting unit
205: Data storing unit
206: Video/analysis results storing device
207: AI model receiving unit
208: AI model updating unit
301: Data receiving unit
302: Analyzing unit
303: Data storing unit
304: Video/analysis results storing device
305: Learning data generating unit
306: Learning data memory
307: AI model generating unit
308: AI model memory
309: AI model transmitting unit

1. A monitoring system, comprising: A plurality of cameras having a function of video analysis by using an AI model; and an analyzing device for generating an AI model that can be used in the cameras, characterized in that
the plurality of cameras respectively detects a certain action through video analysis by using a first AI model for detecting a certain action,
the analyzing device generates a second AI model for detecting a specific object that has carried out a certain action in the case where the certain action is detected by any of the cameras, and transmits the second AI model to one or more of the plurality of cameras, and
the one or more cameras detects a certain person through video analysis by using the second AI model.

2. The monitoring system according to claim 1,
characterized in that the analyzing device regenerates the second AI model in the case where the certain person is detected through video analysis by using the second AI model, and transmits the regenerated second AI model to one or more of the plurality of cameras.

3. The monitoring system according to claim 1, characterized in that
the one or more cameras include a camera that is away from the camera that has detected the certain action by a distance that is smaller than a threshold value.

4. A camera having a function of video analysis by using an AI model, characterized by carrying out:
a process for detecting a certain action through video analysis by using a first AI model for detecting a certain action;
a process for notifying an analyzing device in the case where a certain action is detected;
a process for receiving a second AI model for detecting a certain object that has carried out the certain action from the analyzing device; and
a process for detecting the certain object through video analysis by using the second AI model.

5. An analyzing device for generating an AI model that can be used for video analysis within a camera, characterized by carrying out:
a process for generating a second AI model for detecting a certain object that has carried out a certain action in the case where any of a plurality of cameras has detected the certain action through video analysis by using a first AI model for detecting a certain action; and
a process for transmitting the second AI model to one or more of the plurality of cameras.

6. An AI model generating method for generating an AI model that can be used for video analysis within a camera, characterized by comprising the steps of:
allowing an analyzing device to generate a second AI model for detecting a certain object that has carried out a certain action in the case where any of a plurality of cameras has detected the certain action through video analysis by using a first AI model for detecting a certain action; and
allowing the analyzing device to transmit the second AI model to one or more of the plurality of cameras.
